(19) United States
(12) Patent Application Publication
(10) Pub. No.: US 2024/0288980 A1
(43) Pub. Date: Aug. 29, 2024

(54) SUBSTRATE AND DISPLAY PANEL

(71) Applicant: TCL China Star Optoelectronics Technology Co., Ltd., Shenzhen, Guangdong (CN)

(72) Inventors: Sen YAN, Shenzhen, Guangdong (CN); Kaifeng ZHOU, Shenzhen, Guangdong (CN)

(73) Assignee: TCL China Star Optoelectronics Technology Co., Ltd., Shenzhen, Guangdong (CN)

(21) Appl. No.: 17/623,705

(22) PCT Filed: Oct. 28, 2021
(86) PCT No.: PCT/CN2021/126909

§ 371 Date: Dec. 29, 2021

(30) Foreign Application Priority Data
Sep. 27, 2021 (CN) 202111138184.4
Sep. 27, 2021 (CN) 2021111138253.1

(51) Int. Cl. G06F 3/046; G02F 1/1333; G02F 1/1368; G06F 3/041

(52) U.S. Cl. CPC G06F 3/046; G02F 1/13338; G02F 1/1368; G06F 3/04164; G06F 3/04166

(57) ABSTRACT

A substrate and a display panel are provided. The substrate includes a base and a plurality of first induction lines. Each first induction line is connected with a first output terminal. Some first output terminals are disposed near a first side. Because the first output terminals are divided into two portions and arranged on two sides of the substrate, a quantity of traces at the border zones on the two sides of the substrate connecting the first output terminals and a driver chip can be decreased, and a border width of the panel can be decreased.

### FIELD OF INVENTION

The disclosure relates to a field of display technologies, and more particularly, to a substrate and a display panel.

### BACKGROUND OF INVENTION

At present, a technical solution of a liquid crystal display having a handwriting input function includes electromagnetic inductive handwriting input technology. An electromagnetic signal of an electromagnetic inductive pen is received so that an input position is recognized according to the electromagnetic inductive technology implemented as an independent part assembled onto an outer side of the liquid crystal display or integrated onto an array substrate.

In researching and implementing processes of the existing technology, the inventor of the disclosure has found that traces for recognizing the touch in the electromagnetic inductive panel need connection cables provided from a border zone to a binding zone, and the provision of these traces is not advantageous to the narrow border of the panel.

### SUMMARY OF INVENTION

Embodiments of the disclosure provide a substrate and a display panel capable of narrowing a boarder of a panel.

An embodiment of the disclosure provides a substrate including:
a base including a first side and a second side disposed opposite each other;
a plurality of first induction lines disposed on the substrate; and
a plurality of second induction lines disposed on the substrate and on a layer different from a layer the first induction lines disposed, wherein an arrangement direction of the second induction lines intersects an arrangement direction of the first induction lines, wherein a plurality of first ends of the first induction lines are connected in parallel, each of the first induction lines is connected to a first output terminal, some first output terminals are disposed near the first side, and another first output terminals are disposed near the second side.

Optionally, in some embodiments of the disclosure, the induction lines include first induction sub-lines and second induction sub-lines, the first output terminals connected to the first induction sub-lines are disposed near the first side, the first output terminals connected to the second induction sub-lines are disposed near the second side, and at least one of the first induction sub-lines is disposed adjacent to one of the second induction sub-lines.

Optionally, in some embodiments of the disclosure, at least one of the second induction sub-lines is disposed between adjacent two of the first induction sub-lines, and at least one of the first induction sub-lines is disposed between adjacent two of the second induction sub-lines.

Optionally, in some embodiments of the disclosure, a quantity of the first induction sub-lines is equal to a quantity of the second induction sub-lines.

Optionally, in some embodiments of the disclosure, the first induction sub-lines and the second induction sub-lines are arranged alternately.

Optionally, in some embodiments of the disclosure, distances between any first output terminals near the first side and either adjacent first output terminals are equal, and distances between any first output terminals near the second side and either adjacent first output terminals are equal.

Optionally, in some embodiments of the disclosure, the substrate further includes a third side intersecting the first side, the first induction lines are insulated from the second induction lines, first ends of the second induction lines are connected in parallel, each of the second induction lines is connected to a second output terminal, and the second output terminals are disposed near the third side.

Optionally, in some embodiments of the disclosure, the substrate further includes a chip-on-film (COF) and connection traces, the COF is disposed near the third side, and the connection traces connect the first output terminals and the COF.

Correspondingly, the embodiment of the disclosure further provides a display panel including:
a substrate including a base, a plurality of first induction lines and a plurality of second induction lines, wherein the base includes a first side and a second side disposed opposite each other, the first induction lines are disposed on the base, the second induction lines are disposed on the base and on a layer different from a layer the first induction lines disposed, an arrangement direction of the second induction lines intersects an arrangement direction of the first induction lines, a plurality of first ends of the first induction lines are connected in parallel, each of the first induction lines is connected with a first output terminal, some first output terminals are disposed near the first side, and another first output terminals are disposed near the second side;
an opposing substrate disposed opposite the substrate; and
a liquid crystal layer disposed between the substrate and the opposing substrate.

Optionally, in some embodiments of the disclosure, in a vertical blank period, the first induction line and the second induction line are configured to receive touch signals at an at least one sampling time point, and the first output terminal and the second output terminal are configured to output detection signals.

Optionally, in some embodiments of the disclosure, in a display phase, the first induction line and the second induction line are configured to receive the touch signals at an at least one reference time point, and the first output terminal and the second output terminal are configured to output the detection signals.

Optionally, in some embodiments of the disclosure, the first induction lines include first induction sub-lines and second induction sub-lines, the first output terminals connected to the first induction sub-lines are disposed near the first side, the first output terminals connected to the second induction sub-lines are disposed near the second side, and at least one of the first induction sub-lines is disposed adjacent to one of the second induction sub-lines.

Optionally, in some embodiments of the disclosure, at least one of the second induction sub-lines is disposed between adjacent two of the first induction sub-lines, and at least one of the first induction sub-lines is disposed between adjacent two of the second induction sub-lines.

Optionally, in some embodiments of the disclosure, a quantity of the first induction sub-lines is equal to a quantity of the second induction sub-lines.

Optionally, in some embodiments of the disclosure, the first induction sub-lines and the second induction sub-lines are arranged alternately.

Optionally, in some embodiments of the disclosure, distances between any first output terminals near the first side and either adjacent first output terminals are equal, and distances between any first output terminals near the second side and either adjacent first output terminals are equal.

Optionally, in some embodiments of the disclosure, the base further includes a third side intersecting the first side, the first induction lines are insulated from the second induction lines, first ends of the second induction lines are connected in parallel, each of the second induction lines is connected with a second output terminal, and the second output terminals are disposed near the third side.

Optionally, in some embodiments of the disclosure, the substrate further includes a chip-on-film (COF) and connection traces, the COF is disposed near the third side, and the connection traces connect the first output terminals and the COF.

Optionally, in some embodiments of the disclosure, the substrate may further include a semiconductor layer, a gate insulating layer, a first metal layer, an interlayer insulating layer, a second metal layer, and a passivation layer, the first metal layer is configured to form a gate layer of a thin film transistor, the second metal layer is configured to form a source-drain layer of the thin film transistor, the first induction lines and the first metal layer are formed on a same layer, and the second induction lines and the second metal layer are formed on a same layer.

Optionally, in some embodiments of the disclosure, the substrate may further include a semiconductor layer, a gate insulating layer, a first metal layer, an interlayer insulating layer, a second metal layer, and a passivation layer, the first metal layer is configured to form a gate layer of a thin film transistor, the second metal layer is configured to form a source-drain layer of the thin film transistor, the first induction lines and the second metal layer are formed on a same layer, and the second induction lines and the first metal layer are formed on a same layer.

The embodiment of the disclosure provides the substrate and the display panel. The substrate includes the base and the plurality of first induction lines. The first induction lines are disposed on the base. The first ends of the first induction lines are connected in parallel, each induction line is connected to one first output terminal. Some first output terminals are disposed near the first side. Another first output terminals are disposed near the second side. Because the first output terminals are divided into two portions and arranged on two sides of the substrate, the quantity of traces at the border zones on the two sides of the substrate connecting the first output terminals and a driver chip can be decreased. When the quantity of traces in the border zones on the two sides of the substrate is decreased, the width of the boarder of the panel can be decreased.

### DESCRIPTION OF DRAWINGS

In order to explain the technical solution in the disclosure more clearly, the drawings required for the description of the embodiments will be briefly introduced. The drawings in the following description are just some embodiments of the disclosure. For those skilled in the art, other drawings can be obtained from these drawings without creative works for those skilled in the art.

FIG. 1 is a first schematic structural view showing a substrate provided by an embodiment of the disclosure.

FIG. 2 is a second schematic structural view showing a substrate provided by the embodiment of the disclosure.

FIG. 3 is a third schematic structural view showing a substrate provided by the embodiment of the disclosure.

FIG. 4 is a fourth schematic structural view showing a substrate provided by the embodiment of the disclosure.

FIG. 5 is a fifth schematic structural view showing a substrate provided by the embodiment of the disclosure.

FIG. 6 is a partial enlarged schematic structural view showing a substrate at A in FIG. 5 provided by the embodiment of the disclosure.

FIG. 7 is a sixth schematic structural view showing a substrate provided by the embodiment of the disclosure.

FIG. 8 is a seventh schematic structural view showing a substrate provided by the embodiment of the disclosure.

FIG. 9 is an eighth schematic structural view showing a substrate provided by the embodiment of the disclosure.

FIG. 10 is a schematic structural view showing a display panel provided by the embodiment of the disclosure.

FIG. 11 is a schematic view showing a first electromagnetic touch sampling signal of a display panel provided by the embodiment of the disclosure.

FIG. 12 is a schematic view showing a second electromagnetic touch sampling signal of a display panel provided by the embodiment of the disclosure.

### DETAILED DESCRIPTION OF EMBODIMENTS

The technical solutions in the embodiments of the disclosure will be clearly and completely described in the following with reference to the drawings of the embodiments of the disclosure. Obviously, the described embodiments are only a part of the embodiments of the disclosure, rather than all the embodiments. Based on the embodiments of the disclosure, all other embodiments obtained by those skilled in the art without creative works are deemed as falling within the scope of the disclosure. In addition, it should be understood that the specific implementations described herein are only used to illustrate and explain the disclosure and are not used to limit the disclosure. In the disclosure, in the case when no contrary explanation is made, the used orientation words, such as “up” and “down,” usually refer to the top and bottom of the device in the actual using or working state, and specifically refer to the direction of the drawing; and “inside” and “outside” refer to the outline of the device.

The embodiments of the disclosure provide a substrate and a display panel. Detailed descriptions will be respectively made in the following. It should be noted that the order of descriptions in the following embodiments is not intended to limit the preferred order of the embodiments.

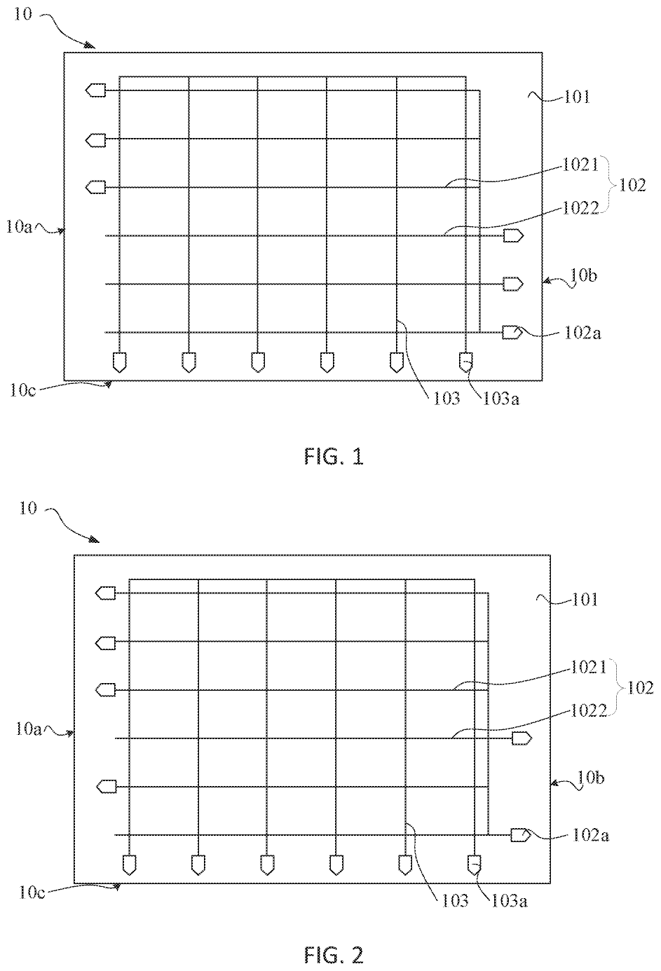

FIG. 1 is a first schematic structural view showing a substrate provided by an embodiment of the disclosure. Referring to FIG. 1, a substrate 10 provided by the embodiment of the disclosure includes a base 101, a plurality of first induction lines 102, and a plurality of second induction lines 103. The base 101 includes a first side 10a and a second side 10b disposed opposite each other. The first induction lines 102 are disposed on the base 101. The second induction lines 103 are disposed on the base 101, and on a layer different from a layer the first induction lines 102 disposed. An arrangement direction of the second induction lines 103 intersects an arrangement direction of the first induction lines 102. First ends of the first induction lines 102 are connected in parallel. Each first induction line 102 is connected to a first output terminal 102a. Some first output terminals 102a are disposed near the first side 10a of the base 101. Another first output terminals 102a are disposed near the second side 10b of the base 101.

The output terminals connected with the first induction lines 102 on the substrate 10 provided by the embodiment of the disclosure are disposed respectively near two sides of the base 101. Because the first output terminals 102a are divided into two portions and arranged on two sides of the substrate 10, the quantity of traces at the border zones on the two sides of the base 101 connecting the first output terminals 102a and a driver chip can be decreased. Because the quantity of traces in the border zones on the two sides of the base 101 is decreased, the width of the boarder of the panel can be decreased.

Referring again to FIG. 1, each of the first induction lines 102 includes a first induction sub-line 1021 and a second induction sub-line 1022. The first output terminals 102a connected to the first induction sub-lines 1021 are disposed near the first side 10a. The first output terminals 102a connected to the second induction sub-lines 1022 are disposed near the second side 10b. At least one first induction sub-line 1021 and a second induction sub-line 1022 are disposed adjacent to each other.

In the embodiment shown in FIG. 1, the first induction sub-lines 1021 may be centralized and disposed on one side of the base 101, and the second induction sub-lines 1022 may be centralized and disposed on the other side of the base 101. Such the configuration can save the space on the substrate 10. For example, when the driver chip is bound to one side close to the second induction sub-lines 1022, the traces for the second induction sub-lines 1022 need not to be disposed in the zone of the second side 10b provided with the first induction sub-lines. Other chips or other traces may be disposed in the zone, in which no second induction sub-line 1022 is provided, thereby facilitating the design of other traces.

It is to be described that the quantity of the first induction sub-lines 1021 may be equal or unequal to the quantity of the second induction sub-lines 1022. In the embodiment shown in FIG. 1, the quantity of the first induction sub-lines 1021 is equal to the quantity of the second induction sub-lines 1022. The first induction sub-lines 1021 and the second induction sub-lines 1022 are configured to have the same quantity, so that the quantity of the first output terminals 102a near the first side 10a is equal to the quantity of the first output terminals 102a near the second side 10b. The first output terminals 102a disposed near two sides are configured to have the same quantity, so that the quantities of traces in the border zones on two sides are equal to each other, the borders on two sides are correspondingly decreased, and the bus lines become more uniform.

Referring again to FIG. 1, the substrate 10 further includes a third side 10c. First ends of the second induction lines 103 are connected in parallel. Each second induction line 103 is connected with a second output terminal 103a. The second output terminals 103a are disposed near the third side 10c.

It is to be described that the electromagnetic induction touch technology is implemented with the aid of an electromagnetic pen emitting an electromagnetic signal to interact with the first induction lines 102 and the second induction lines 103 on the substrate 10 so that the touch control can be performed. When the electromagnetic pen approaches, the first induction lines 102 and the second induction lines 103 on the substrate 10 sense the electromagnetic signal of the pen. Because coil loops are formed between the first induction lines 102 and between the second induction lines 103, the electromagnetic signal makes the current between the first induction lines 102 be different from the current between the second induction lines 103. The coordinate position of the electromagnetic signal is determined by detecting the current difference between different output terminals. Because the second induction lines 103 intersect an arrangement direction of the first induction lines 102, the position of the pen can be obtained by calculating the difference of the magnetic flux according to signals received in the array of the first induction lines 102 and the second induction lines 103 with different directions. In addition, because the electromagnetic pen has the transversal pressure sensor, the pressure is transferred to the pressure sensor through the pen core after the pen tip is stressed, the pressure change causes the change of the electromagnetic signal outputted from the electromagnetic pen, and an electromagnetic induction board can show different pressure sensations according to the sensing signal.

Optionally, the first induction lines 102 may be perpendicular to an arrangement direction of the second induction lines 103. It is understandable that when a certain position in the display panel is touched, the magnetic field of the coil at the position changes. The detection signal outputted from the induction line changes, thereby determining the coordinate value of the position in the arrangement direction of the first induction line 102. Similarly, the detection signal outputted from the second induction line 103 also changes, thereby determining the coordinate value of the position in the arrangement direction of the second induction line 103, so that the coordinate position of the touch position on the plane of the display panel can be finally determined.

It is to be described that the first ends of the first induction lines 102 are connected in parallel, and the first ends of the second induction lines 103 are connected in parallel. So, upon touch sensing, loops between any two of the first induction lines 102 and between any two of the second induction lines 103 can be formed for the signal output. In addition, the first induction line 102 and the second induction line 103 closer to the touch position detect the higher signal intensity, and the first induction line 102 and the second induction line 103 far from the touch position detect the lower signal intensity. Thus, the touch position can be positioned with the high precision.

FIG. 2 is a second schematic structural view showing a substrate provided by the embodiment of the disclosure. Referring to FIG. 2, at least one second induction sub-line 1022 is disposed between adjacent two of the first induction sub-lines 1021, and at least one first induction sub-line 1021 is disposed between adjacent two of the second induction sub-lines 1022.

The quantity of the second induction sub-lines 1022 between adjacent two of the first induction sub-lines 1021, and the quantity of the first induction sub-lines 1021 between adjacent two of the second induction sub-lines 1022 may be configured according to the actual requirements, and the disclosure is not specifically restricted thereto.

In the embodiment shown in FIG. 2, the first induction sub-lines 1021 and the second induction sub-lines 1022 of the first output terminals 102a respectively connected to two sides may be arranged alternately. After at least one second induction sub-line 1022 is disposed between the adjacent two first induction sub-lines 1021, the first output terminals 102a correspondingly connected to the adjacent two first induction sub-lines 1021 are farther from each other. Thus, the width of the trace connected to the first output terminal 102a in the border zone can be properly increased. Similarly, at least one first induction sub-line 1021 is disposed between two adjacent second induction sub-lines 1022. Thus, the resistance of the trace can be decreased, and the sensitivity of the first induction lines 102 can be increased.

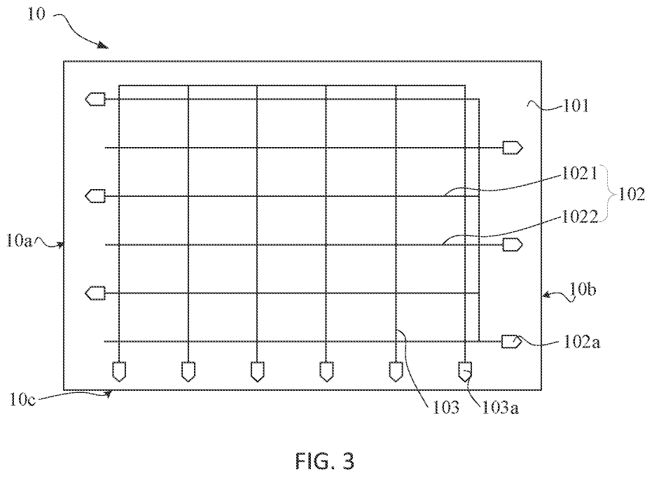

FIG. 3 is a third schematic structural view showing a substrate provided by the embodiment of the disclosure. Referring to FIG. 3, the first induction sub-lines 1021 and the second induction sub-lines 1022 are arranged alternately. Disposing the first induction sub-lines 1021 and the second induction sub-lines 1022 alternately can increase the distance between the first output terminals 102a near the same side, thereby avoiding the short circuit or signal crosstalk problem caused by the too dense first output terminals 102a. In addition, after the distance between the first output terminals 102a on the same side is increased, the length of the trace connecting the first output terminal 102a to the driver chip is also correspondingly increased. Thus, the width of the trace connecting the first output terminal 102a to the driver chip can be properly increased, so that the resistance of the trace can be decreased, and the sensitivity of the first induction lines 102 can be increased.

Distances between any first output terminals 102a near the first side 10a and either adjacent first output terminals 102a, are equal, and distances between any first output terminals 102a near the second side 10b and either adjacent first output terminals 102a are equal. That is, the first output terminals 102a respectively disposed on two sides are evenly arranged, intervals between the first induction lines 102 are the same, and the first induction lines 102 have the same length. Thus, the resistance difference between the first induction lines 102 can be decreased, and the sensitivity of the first induction lines 102 can be increased.

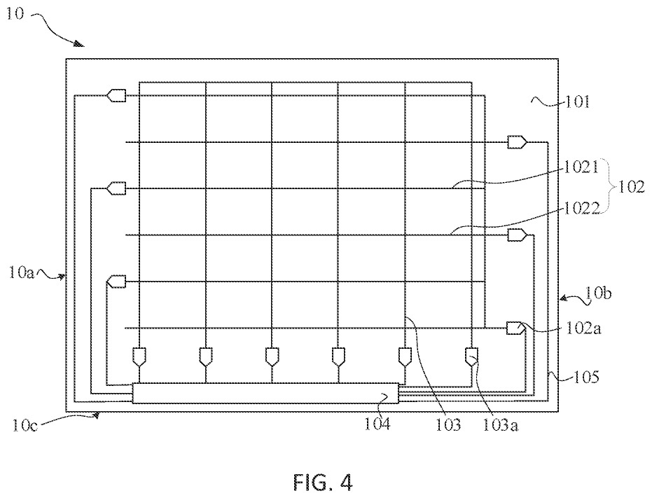

FIG. 4 is a fourth schematic structural view showing a substrate provided by the embodiment of the disclosure. Referring to FIG. 4, the substrate 10 further includes a chip-on-film (COF) 104 and connection traces 105. The COF 104 is disposed near the third side 10c. The connection traces 105 connect the first output terminals 102a to the COF 104. The COF 104 is bound onto the base 101. A driver chip (not shown in the drawing) disposed on the COF 104 receives detection signals outputted from the first output terminals 102a and transmits the detection signals to the display panel. Because the first output terminals 102a connected to the first induction lines 102 are respectively disposed on the two sides of the substrate 10, the quantity of the connection traces 105 on the two sides of the substrate 10 is decreased. On one hand, the width of the zone of the substrate 10 provided with the connection traces 105 can be decreased, and the border of the display panel can be thus decreased. On the other hand, the decrease of the quantity of the connection traces 105 can properly increase the widths of the connection traces 105 and thus decrease the resistance.

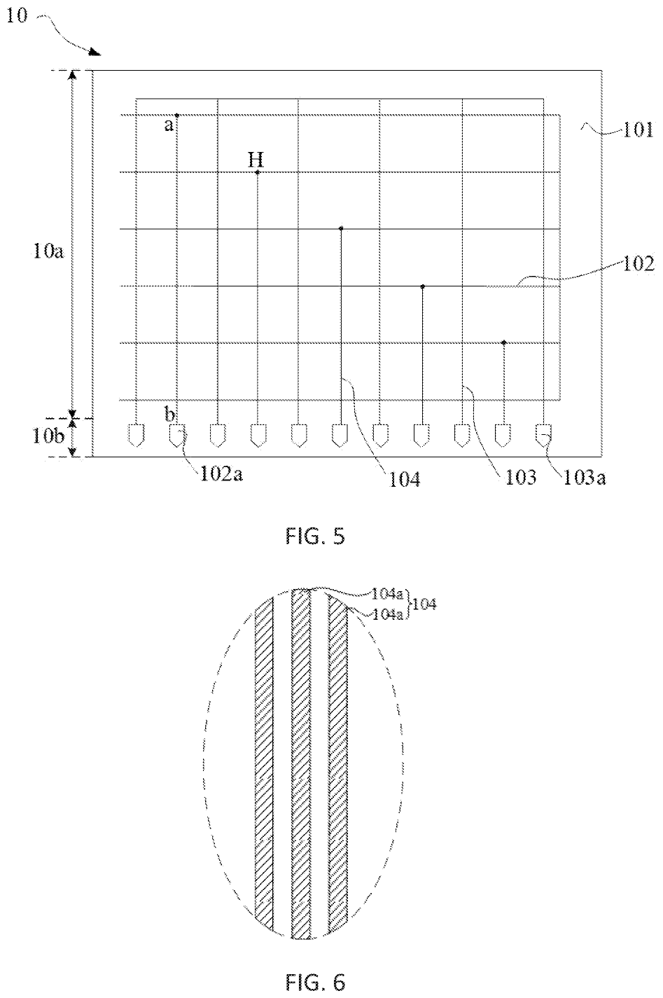

Please refer to FIG. 5. FIG. 5 is a schematic diagram of a fifth structure of a substrate provided by an embodiment of the present application. The substrate 10 provided by the embodiment of the present application includes a touch zone 10a and a binding zone 10b provided at one side of the touch area 10a. The substrate 10 includes a base 101, a plurality of first induction lines 102, and a plurality of second induction lines 103. The first induction line 102 is disposed on the base 101 and correspondingly disposed in the touch zone 10a. One end of each first induction line 102 is connected in parallel. Each first induction line 102 is connected to a first output terminal 102a, and the first output terminal 102a is arranged corresponding to the binding zone 10b. The second induction line 103 is disposed on the base 101 and correspondingly disposed in the touch zone 10a. The second induction line 103 and the first induction line 102 are arranged in different layers. An arrangement direction of the second induction lines 103 and an arrangement direction of the first induction lines 102 intersects. One end of the second induction line 103 is connected in parallel. Each second induction line 103 is connected to a second output terminal 103a. The second output terminal 103a is disposed corresponding to the binding zone 10b. A transfer line 104 and the first induction line 102 are arranged in different layers. A first end a of at least one transfer line 104 is connected to one first induction line 102 through a transfer hole H. A second end b of a transfer line 104 is connected to one first output terminal 102a.

Among them, please refer to FIG. 5 again, each first induction line 102 is connected to one transfer line 104. The transfer lines 104 are sequentially connected to the first induction lines 102 along the arrangement direction of the first induction lines 102.

The transfer lines 104 are sequentially connected to the first induction lines 102 along the arrangement direction of the first induction lines 102, so that wiring lengths between any two first output terminals 102a are equal. Therefore, signal loss difference caused by the first induction lines 102 when the first output terminals 102a output signals can be reduced, and thereby improving the sensitivity of the first induction lines 102. It should be noted that, FIG. 1 illustrates an example in which the transfer lines 104 are connected to the first induction lines 102 in order along the arrangement direction of the first induction lines 102. The transfer lines 104 may not be connected to the first induction lines 102 in sequence. It is only necessary to ensure that the transfer lines 104 and the first induction lines 102 are connected one by one. The application does not limit a connection sequence of the transfer lines 104 and the first induction lines 102.

Optionally, the distances between any one first output terminal 102a and two adjacent first output terminals 102a are equal, and the distances between any one second output terminal 103a and the adjacent second output terminal 103a are equal. That is, the first output terminals 102a are evenly arranged, so that intervals between the first induction lines 102 are equal, and line lengths of the first induction lines 102 are equal. As a result, resistance difference between the first induction lines 102 can be reduced, and the sensitivity of the first induction lines 102 can be improved. In the same way, the second output terminals 103a are evenly arranged, so that intervals between the second induction lines 103 are equal and line lengths of the second induction lines 103 are equal, which can reduce resistance difference between the second induction lines 103 and improve the sensitivity of the second induction lines 103.

Optionally, the first output terminals 102a and the second output terminals 103a are alternately arranged. Distances between any one of the first output terminals 102a and either one of adjacent second output terminals 103a are equal. The first output terminal 102a is connected to the first induction line 102, and the second output terminal 103a is connected to the second induction line 103. The first output terminals 102a and the second output terminals 103a are alternately arranged. The uniform arrangement can make interval between the first induction lines 102 equal, make interval between the second induction lines 103 equal, and make arrangement of the first induction lines 102 and the second induction lines 103 more uniform, which is beneficial to reduce resistance and improve sensitivity of the first induction lines 102 and the second induction lines 103.

In the substrate 10 provided by the embodiment of the present application, the first induction line 102 on the substrate 10 is connected to an output terminal through a transfer line 104. Thus, the first output terminal 102a is also arranged in the binding zone 10b. The first induction line 102 and the first output terminal 102a are connected through the transfer trace 104 provided in the panel. There is no need to provide connection traces on the base 101 to connect the first output terminals 102a and a driver chip located in the binding zone 10b. Number of lines in a border zone of the base 101 is reduced, and a border width of the panel can be narrowed.

Optionally, please refer to FIG. 6. FIG. 6 is a partial enlarged schematic diagram of A in FIG. 1 according to an embodiment of the present application. Each transfer line 104 includes a plurality of sub-transfer lines 104a connected in parallel. A plurality of sub-transfer lines 104a are connected in parallel, and current through each sub-transfer line 104a is reduced, so that resistance of the transition lines 104 can be reduced.

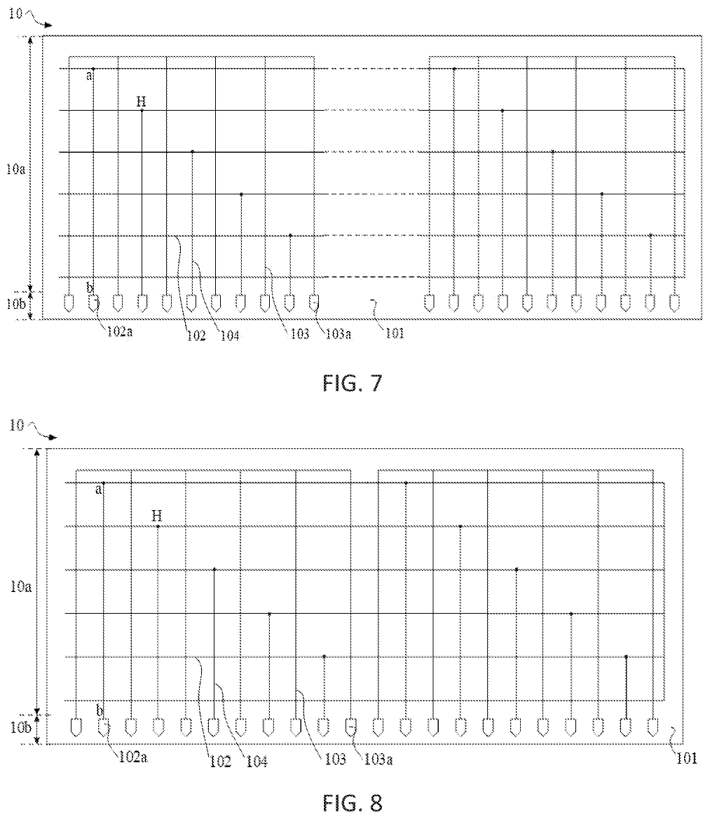

Please refer to FIG. 7, FIG. 7 is a schematic diagram of a sixth structure of a substrate provided by an embodiment of the present application. Each first induction line 102 is connected to a plurality of transfer lines 104. The transfer lines 104 are divided into multiple groups, and each group of transfer lines 104 is connected to the first induction lines 102 in sequence along the arrangement direction of the first induction lines 102.

In the embodiment shown in FIG. 7, the transfer lines 104 are periodically arranged on the substrate 10. In this way, a same first induction line 102 can realize periodic multi-channel output. Through periodic multi-channel output, the report rate of the first induction line 102 can be improved, and the sensitivity of the first induction line 102 can be improved. In addition, this structure in which one first induction line 102 is connected to a plurality of transfer lines 104 can be applied to a large-size panel.

It is understandable that each group of transfer lines 104 is connected to the first induction lines 102 in sequence along the arrangement direction of the first induction lines 102, so that an arrangement order of the first output terminals 102a in each group correspond to the arrangement sequence of the first induction lines 102. As a result, during sampling, a more regular sampling result can be obtained. In addition, the periodic arrangement of the transfer lines 104 can prevent the plurality of first output terminals 102a of the same first induction line 102 from disposed too far apart to cause uncontrollable errors between signals output from two first output terminals 102a and affect the sensing result.

In detail, please refer to FIG. 8, FIG. 8 is a schematic diagram of a seventh structure of the substrate provided by the embodiment of the present application. Each first induction line 102 is connected to two transfer lines 104. The transfer line 104 is divided into two groups, and each group of the transfer lines 104 is connected to the first induction lines 102 in sequence along the arrangement direction of the first induction lines 102.

In the embodiment shown in FIG. 8, each first induction line 102 is connected to two transfer lines 104 as an example for description. Such a design can be applied to large-size display panels. Arranging the transfer lines 104 periodically can reduce length of the signal transmission path when the first induction line 102 is too long, so that the signal output by the first output terminal 102a is more accurate. In addition, when the signal of the first output terminal 102a is sampled during the sampling time, the first induction line 102 can be periodically sampled, which improves the reporting rate, makes the sampling result more accurate, and effectively improves the sensitivity of sensing.

Please refer to FIG. 9, FIG. 9 is a schematic diagram of an eighth structure of a substrate provided by an embodiment of the present application. The substrate 10 further includes a chip-on-film 105 and connection traces 106. The chip-on-film 105 is provided corresponding to the binding zone 10b. The connection traces 106 connect the first output terminals 102a and the chip-on-film 105. The connection traces 106 connect the second output terminal 103a and the chip-on-film 105.

A driver chip (not shown in the figure) is provided on the chip-on-film 105. The driver chip on the chip-on-film 105 receives the detection signal output by the first output terminal 102a and transmits the detection signal to the display panel. Because the first induction line 102 is connected to the first output terminal 102a through the transfer line 104 arranged in the panel, the arrangement of connecting lines on both sides of the substrate 10 is omitted. On one hand, the width of an area of the substrate 10 can be reduced, thereby reducing the border of the display panel. On the other hand, because the first induction line 102 is connected to the first output terminal 102a through the transfer trace 104 arranged in the panel and then connected to the chip-on-film 105 through the connection traces 106, width of the connection traces 106 can be appropriately widened to reduce resistance.

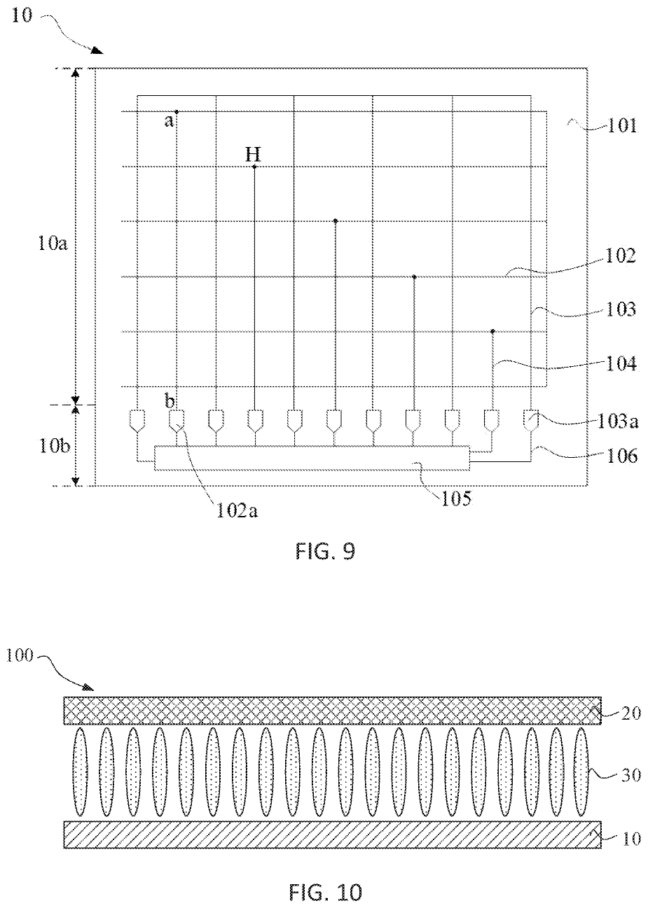

Correspondingly, the embodiment of the disclosure further provides a display panel. FIG. 10 is a schematic structural view showing a display panel provided by the embodiment of the disclosure. Referring to FIG. 10, a display panel 100 includes a substrate 10, an opposing substrate 20, and a liquid crystal layer 30. The substrate 10 has been mentioned hereinabove. The opposing substrate 20 is disposed opposite the substrate 10. The liquid crystal layer 30 is disposed between the substrate 10 and the opposing substrate 20.

In the embodiment, explanations will be made with the substrate 10 serving as an array substrate. Actually, the substrate 10 may also be an electromagnetic induction board or a color filter substrate, and the type of the substrate 10 of the disclosure is not particularly restricted.

In the display panel 100, the first induction lines 102 and the second induction lines 103 for the electromagnetic touch control may be integrated onto an array substrate. The array substrate may further include a semiconductor layer, a gate insulating layer, a first metal layer, an interlayer insulating layer, a second metal layer, and a passivation layer. Optionally, the first metal layer may be used for formation of a gate layer of a thin film transistor, and the second metal layer may be used for formation of a source-drain layer of the thin film transistor. The first induction lines 102 and the first metal layer may be formed on the same layer, and the second induction lines 103 and the second metal layer may be formed on the same layer. Alternatively, the first induction lines 102 and the second metal layer may be formed on the same layer, and the second induction lines 103 and the first metal layer may be formed on the same layer. Thus, the first induction lines and the second induction lines may be formed while the thin film transistors are formed on the array substrate, so that the electromagnetic touch pad is integrated into the array substrate. With such the integration, the thickness of the display panel 100 can be decreased, so that the display panel 100 becomes lighter and thinner. In addition, integrating the first induction lines and the second induction lines into the array substrate may further simplify the manufacturing process, and decrease the manufacturing cost.

In addition, metal layers for the first induction lines and the second induction lines may also be added onto the array substrate, thereby preventing the metal traces on the same layer from getting too dense to cause the short-circuit or signal crosstalk problem.

It is understandable that other film layers may further be disposed on the array substrate. The specific assemblies of the semiconductor layer, the gate insulating layer, the first metal layer, the interlayer insulating layer, the second metal layer, the passivation layer and other film layers are well known in the art, and detailed descriptions thereof will be omitted.

The embodiment of the disclosure provides a display panel 100. The display panel 100 includes a substrate 10. Output terminals connected to induction lines on the substrate 10 are respectively disposed near the two sides of the substrate. Because the first output terminals are divided into two portions and arranged on the two sides of the substrate 10, the quantity of traces the border zones on the two sides of the substrate connecting the first output terminals and the driver chip can be decreased. When the quantity of traces in the border zones on the two sides of the substrate is decreased, the width of the boarder of the panel can be decreased. In addition, because the quantity of traces in the border zone is decreased, the widths of the traces can be properly increased to decrease the resistance.

In addition, the display panel 100 provided by the disclosure is an electromagnetic touch display panel. The basic principle of the electromagnetic touch display panel is to perform the determination according to magnetic field change generated in the operation process of the electromagnetic pen interacting with the induction coils under the display panel 100. The induction coils are respectively formed by the first induction lines and the second induction lines. Because it is well known in the art, detailed descriptions thereof will be omitted. The electromagnetic pen is a signal transmitter, the first induction lines and the second induction lines are the signal receiving terminals. When a touch event occurs, the magnetic flux changes, and the touch position is determined according to the changed magnetic flux.

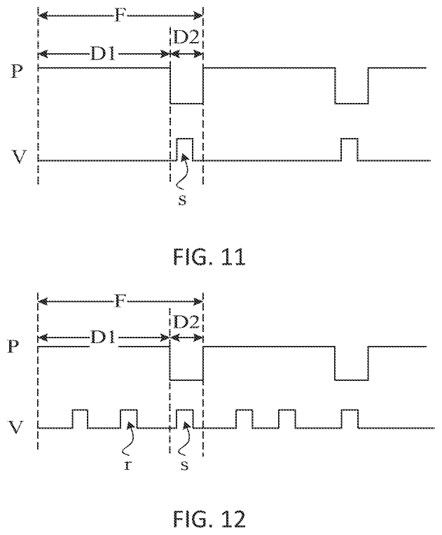

FIG. 11 is a schematic view showing a first electromagnetic touch sampling signal of a display panel provided by the embodiment of the disclosure. Referring to FIG. 11, in a vertical blank period D2, the first induction line and the second induction line receive the touch signal at an at least one sampling time point, and the first output terminal and the second output terminal output the detection signal. FIG. 6 is a schematic view showing a display cycle P corresponding to a sampling signal V.

It is understandable that, in the display process of the touch display panel 100, scanning always starts from an upper left corner of the display region and advances horizontally. Meanwhile, the scanning point also moves down at a slower rate. When the scanning point reaches a right side edge of the display region, the scanning point quickly returns to the left side, the scanning of the second line restarts under the starting point of the first line, the return process between the lines is referred to as a horizontal blank period (HBlank). A complete image scan signal consists of a sequence of line signals separated by the horizontal blank intervals. After the scanning point has scanned all the lines, it needs to return to the upper left corner from the lower right corner of the display region and starts a new scan. The time interval after all the lines have been scanned and before the new scan starts is referred to as a vertical blank period D2 or a field blank period (VBlank). In the display cycle P shown in FIG. 6, the display phase D1 and the vertical blank period D2 commonly constitute one frame F.

The embodiment of the disclosure performs the centralized sampling on the electromagnetic touch using the vertical blank period D2. The waveforms of the scan signals and the sampling signal V of the display panel are staggered, such that the noise interference between the signals can be prevented. In the sampling signal V, one or a plurality of sampling time points “s” are configured in correspondence with the vertical blank period D2. The first induction line and the second induction line receive the touch signal at the sampling time point “s,” and perform outputting through the first output terminal and the second output terminal.

It is to be described that one sampling time point “s” for the schematic illustration is set in each frame F in FIG. 11. However, the disclosure does not intend to restrict the quantity of the sampling time point(s) “s”, the sampling time of the sampling time point “s” and the time interval between adjacent two sampling time points “s.”

FIG. 12 is a schematic view showing a second electromagnetic touch sampling signal of a display panel provided by the embodiment of the disclosure. Referring to FIG. 12, in the display phase D1 in some embodiments, the first induction line and the second induction line receive the touch signal at an at least one reference time point, and the first output terminal and the second output terminal output the detection signal.

On the basis of the previous embodiment, the reference time points “r” of the display phase D1 are added. It is to be described that these reference time points “r” may be interfered by the scan signal, so that the output detection signal becomes inaccurate. However, these reference time points “r” may still function as references, and corrections may be performed through algorithms to enhance the touch accuracy and increase the report rate.

It is to be described that two reference time points “r” for the schematic illustration are set in each frame F in FIG. 12. However, the disclosure does not intend to restrict the quantity of the reference time point(s) “r,” the sampling time of the reference time point “r” and the time interval between adjacent two reference time points “r.”

Because the scan signal of the display panel 100 and the sampling signal V of the electromagnetic touch control are waveform signals, a predetermined noise interference between the waveform signals may be generated. Optionally, in order to prevent the noise interference from affecting the sampling result, sampling may be made using the time-division multiplex driving method. Specifically, the time-division multiplex driving method represents that display driving and touch sampling are performed concurrently in the display phase D1. In the time-division multiplex driving method, the scan signal is provided to the drive circuit on the substrate 10 upon display driving in the display stage D1, so that the display panel 100 performs displaying. When touch sampling is performed in the display phase D1, inputting of the scan signal pauses, and the sampling signal V is inputted to prevent the sampling signal V from being interfered by the scan signal. Such the time-division multiplex driving method can improve the mutual interference between the scan signal and the sampling signal V and decrease the noise intensity.

It is to be described that the display panel 100 may further include other devices, such as a gate driver on array (GOA) circuit, an encapsulation layer and the like. Other devices of the display panel 100 and assemblies thereof are well known in the art, and detailed descriptions thereof will be omitted herein.

Detailed introductions have been made to the substrate and the display panel provided by the embodiments of the disclosure. In the disclosure, specific examples are used to explain the principles and implementation of the disclosure. The descriptions of the above-mentioned embodiments are only used to help the understanding of the method and core idea of the disclosure. Meanwhile, those skilled in the art will make changes to the specific implementation and the application scope according to the idea of the disclosure. In summary, the contents of the specification should not be construed as a limitation to the disclosure.

What is claimed is:

1. A substrate, comprising:
a base comprising a first side and a second side disposed opposite each other;
a plurality of first induction lines disposed on the base; and
a plurality of second induction lines disposed on the base and on a layer different from a layer the first induction lines disposed, wherein an arrangement direction of the second induction lines intersects an arrangement direction of the first induction lines; and
wherein first ends of the plurality of first induction lines are connected in parallel, each of the first induction lines is connected to a first output terminal, some first output terminals are disposed near the first side, and another first output terminals are disposed near the second side.

2. The substrate according to claim 1, wherein the first induction lines comprise a first induction sub-lines and a second induction sub-lines, the first output terminals connected to the first induction sub-lines are disposed near the first side, the first output terminals connected to the second induction sub-lines are disposed near the second side, and at least one of the first induction sub-lines is disposed adjacent to one of the second induction sub-lines.

3. The substrate according to claim 2, wherein at least one of the second induction sub-lines is disposed between adjacent two of the first induction sub-lines, and at least one of the first induction sub-lines is disposed between adjacent two of the second induction sub-lines.

4. The substrate according to claim 2, wherein a quantity of the first induction sub-lines is equal to a quantity of the second induction sub-lines.

5. The substrate according to claim 2, wherein the first induction sub-lines and the second induction sub-lines are arranged alternately.

6. The substrate according to claim 5, wherein distances between any first output terminals near the first side and either adjacent first output terminals are equal, and distances between any first output terminals near the second side and either adjacent first output terminals are equal.

7. The substrate according to claim 1, wherein the base further comprises a third side intersecting the first side, the first induction lines are insulated from the second induction lines, first ends of the second induction lines are connected in parallel, each of the second induction lines is connected to a second output terminal, and the second output terminals are disposed near the third side.

8. The substrate according to claim 7, wherein the substrate further comprises a chip-on-film (COF) and connection traces, the COF is disposed near the third side, and the connection traces connect the first output terminals and the COF.

9. A display panel, comprising:
a substrate comprising a base, a plurality of first induction lines, and a plurality of second induction lines, wherein the base comprises a first side and a second side disposed opposite each other, the first induction lines are disposed on the base, the second induction lines are disposed on the base and on a layer different from a layer the first induction lines disposed, an arrangement direction of the second induction lines intersects an arrangement direction of the first induction lines, a plurality of first ends of the first induction lines are connected in parallel, each of the first induction lines is connected with a first output terminal, some first output terminals are disposed near the first side, and another first output terminals are disposed near the second side;
an opposing substrate disposed opposite the substrate; and
a liquid crystal layer disposed between the substrate and the opposing substrate.

10. The display panel according to claim 9, wherein in a vertical blank period, the first induction line and the second induction line are configured to receive touch signals at an at least one sampling time point, and the first output terminal and a second output terminal are configured to output detection signals.

11. The display panel according to claim 10, wherein in a display phase, the first induction line and the second induction line are configured to receive the touch signals at an at least one reference time point, and the first output terminal and the second output terminal are configured to output the detection signals.

12. The display panel according to claim 9, wherein the first induction lines comprise first induction sub-lines and second induction sub-lines, the first output terminals connected to the first induction sub-lines are disposed near the first side, the first output terminals connected to the second induction sub-lines are disposed near the second side, and at least one of the first induction sub-lines is disposed adjacent to one of the second induction sub-lines.

13. The display panel according to claim 12, wherein at least one of the second induction sub-lines is disposed between adjacent two of the first induction sub-lines, and at least one of the first induction sub-lines is disposed between adjacent two of the second induction sub-lines.

14. The display panel according to claim 12, wherein a quantity of the first induction sub-lines is equal to a quantity of the second induction sub-lines.

15. The display panel according to claim 12, wherein the first induction sub-lines and the second induction sub-lines are arranged alternately.

16. The display panel according to claim 15, wherein distances between any first output terminals near the first side and either adjacent first output terminals are equal, and distances between any first output terminals near the second side and either adjacent first output terminals are equal.

17. The display panel according to claim 9, wherein the base further comprises a third side intersecting the first side, the first induction lines are insulated from the second induction lines, first ends of the second induction lines are connected in parallel, each of the second induction lines is connected with a second output terminal, and the second output terminals are disposed near the third side.

18. The display panel according to claim 17, wherein the substrate further comprises a chip-on-film (COF) and connection traces, the COF is disposed near the third side, and the connection traces connect the first output terminals and the COF.

19. The display panel according to claim 9, wherein the substrate further comprises a semiconductor layer, a gate insulating layer, a first metal layer, an interlayer insulating layer, a second metal layer, and a passivation layer, the first metal layer is configured to form a gate layer of a thin film transistor, the second metal layer is configured to form a source-drain layer of the thin film transistor, the first induction lines and the first metal layer are formed on a same layer, and the second induction lines and the second metal layer are formed on a same layer.

20. The display panel according to claim 9, wherein the substrate further comprises a semiconductor layer, a gate insulating layer, a first metal layer, an interlayer insulating layer, a second metal layer, and a passivation layer, the first metal layer is configured to form a gate layer of a thin film transistor, the second metal layer is configured to form a source-drain layer of the thin film transistor, the first induction lines and the second metal layer are formed on a same layer, and the second induction lines and the first metal layer are formed on a same layer.
